(19) United States
(12) Patent Application Publication
(10) Pub. No.: US 2024/0376773 A1
(43) Pub. Date: Nov. 14, 2024

(54) Pleated Window Screen Device

(71) Applicant: Charles Driver, Indianapolis, IN (US)

(72) Inventor: Charles Driver, Indianapolis, IN (US)

(21) Appl. No.: 18/195,990

(22) Filed: May 11, 2023

(51) Int. Cl. E06B 9/52; E06B 9/06

(52) U.S. Cl. CPC E06B 9/52; E06B 9/0669

(57) ABSTRACT

A pleated window screen device includes a frame that has a plurality of intersecting members oriented at right angles with each other for positioning in a window next to a window air conditioning unit. A screen is attached to the frame such that the screen completely covers an opening defined by the frame. The screen is comprised of a mesh material to pass air through the mesh screen while inhibiting insects from passing through the screen. A curtain is movably disposed in the frame which can be urged between a collapsed position and an expanded position. The curtain extends across a full width of the frame when the curtain is in the expanded position to inhibit air from flowing through the frame.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to window screen devices and more particularly pertains to a new window screen device for facilitating a window to vent air when a window air conditioning unit is not turned on. The window screen device includes a frame, a pleated curtain movably disposed in the frame and a screen attached to the frame. The pleated curtain is movable between an expanded position or a collapsed position to facilitate the frame to be closed when the window air conditioning unit is running or to facilitate the frame to be open when the air conditioning unit is not running.

### (2) Description of Related Art Including Information Disclosed Under 37 CFR 1.97 and 1.98

The prior art relates to window screen devices including a variety of window curtains that each includes a pleated curtain for closing a space between a window air conditioning unit and a frame of a window and an adjustable window frame that has a plurality of tracks, a pleated curtain slidably disposed in the tracks and a screen positioned in the frame. In no instance does the prior art disclose a fixed window frame, a pleated curtain slidably disposed in the fixed window frame and a screen positioned in the frame.

### (h) BRIEF SUMMARY OF THE INVENTION

An embodiment of the disclosure meets the needs presented above by generally comprising a frame that has a plurality of intersecting members oriented at right angles with each other for positioning in a window next to a window air conditioning unit. A screen is attached to the frame such that the screen completely covers an opening defined by the frame. The screen is comprised of a mesh material to pass air through the mesh screen while inhibiting insects from passing through the screen. A curtain is movably disposed in the frame which can be urged between a collapsed position and an expanded position. The curtain extends across a full width of the frame when the curtain is in the expanded position to inhibit air from flowing through the frame.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a pleated window screen device according to an embodiment of the disclosure.

FIG. 2 is a back view of an embodiment of the disclosure.

FIG. 3 is a left side phantom view of an embodiment of the disclosure.

FIG. 4 is a top phantom view of an embodiment of the disclosure.

FIG. 5 is a front view of an embodiment of the disclosure showing a pleated curtain in collapsed position.

FIG. 6 is a top phantom view of an embodiment of the disclosure showing a pleated curtain in a collapsed position.

FIG. 7 is a front perspective view of an embodiment of the disclosure showing a pleated curtain in a collapsed position.

FIG. 8 is a perspective in-use view of an embodiment of the disclosure.

### (j) DETAILED DESCRIPTION OF THE INVENTION

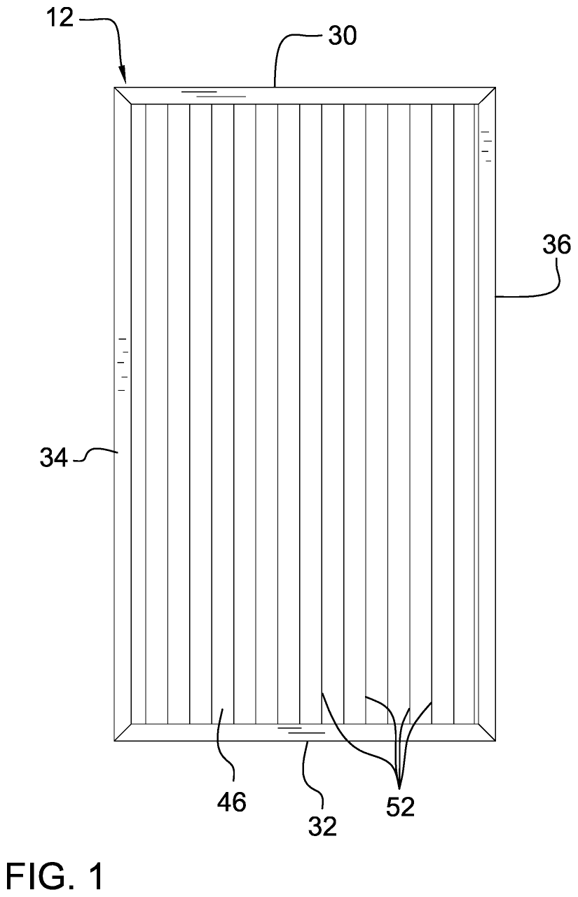

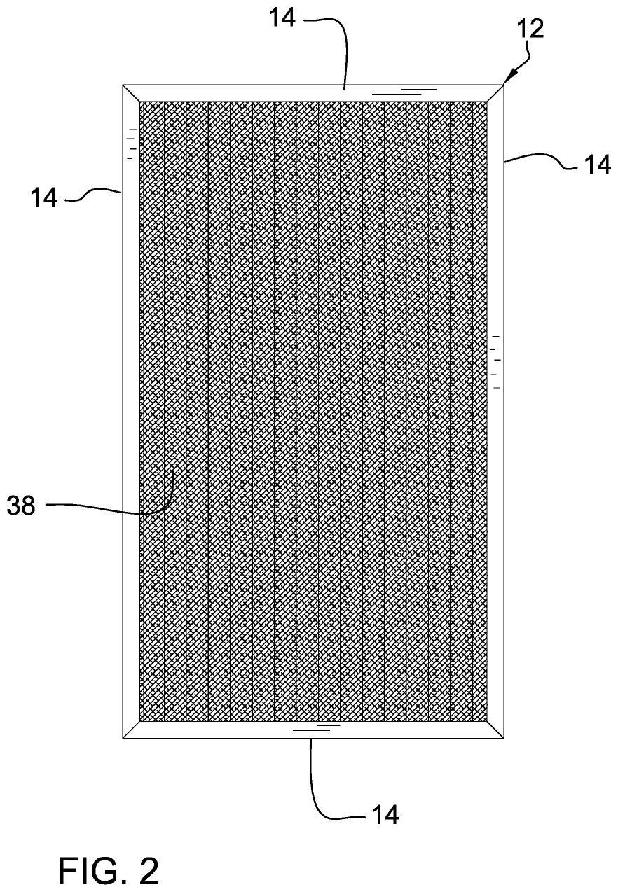

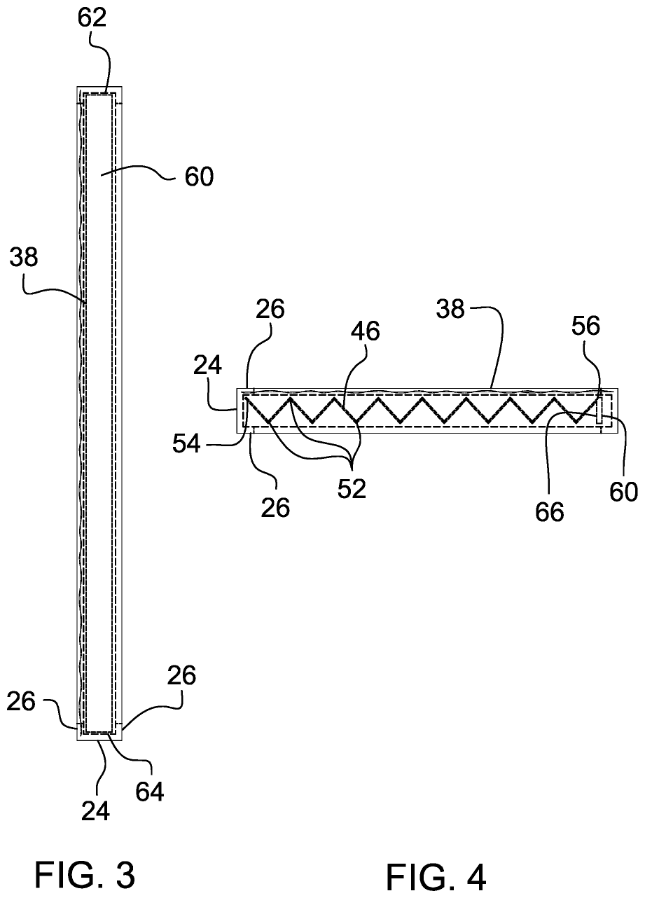

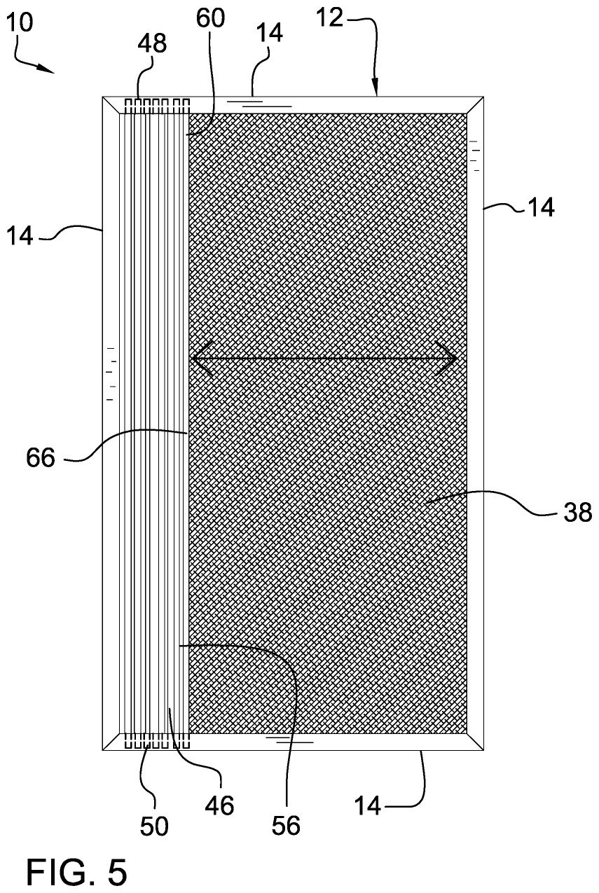

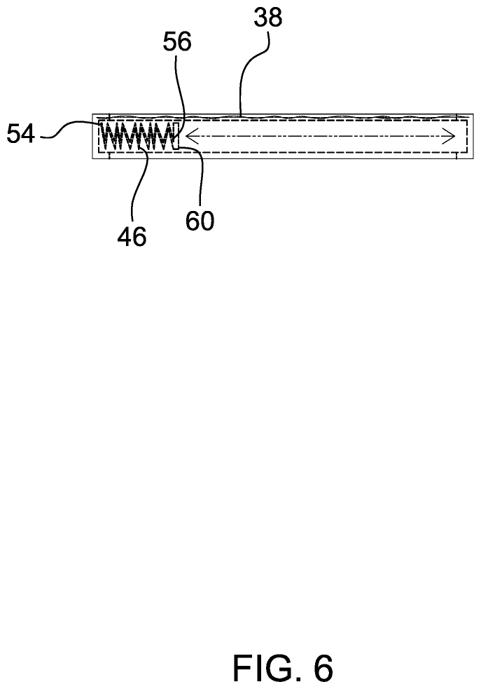

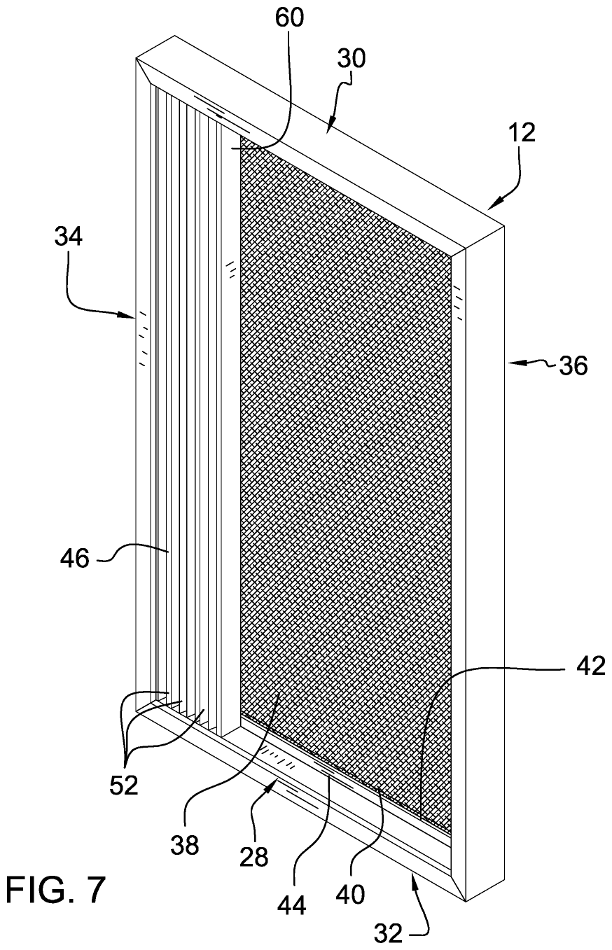

With reference now to the drawings, and in particular to FIGS. 1 through 8 thereof, a new window screen device embodying the principles and concepts of an embodiment of the disclosure and generally designated by the reference numeral 10 will be described.

As best illustrated in FIGS. 1 through 8, the pleated window screen device 10 generally comprises a frame 12 that has a plurality of intersecting members 14 that is oriented at right angles with each other. In this way the frame 12 can be positioned in a window 16 next to a window air conditioning unit 18. The window 16 may be a window 16 in an exterior wall 20 of a building 22 and the window air conditioning unit 18 may be a window air conditioning unit of any conventional design. Furthermore, the frame 12 may be manufactured in a variety of dimensions to snugly fit between the window air conditioning unit 18 and a frame 23 of the window 16.

Each of the plurality of intersecting members 14 comprises a central panel 24 which extends between a pair of outward panels 26. Each of the outward panels 26 associated with a respective one of the intersecting members 14 is perpendicularly oriented with the central panel 24 of the respective intersecting member 14 such that each of the plurality of intersecting members 14 has a U-shape. Additionally, each of the outward panels 26 associated with each of the intersecting members 14 is coupled to a respective one of the outward panels 26 associated with an adjacent one of the intersecting members 14 such that each of the outward panels 26 associated with each of the intersecting members 14 is directed into an opening 28 defined by the plurality of intersecting members 14. The central panel 24 associated with each of the plurality of intersecting members 14 is coupled to the central panel 24 associated with a respective pair of the plurality of intersecting members 14.

The plurality of intersecting members 14 includes a top member 30, a bottom member 32, a first lateral member 34 and a second lateral member 36. Each of the first lateral member 34 and the second lateral member 36 has a length that is greater than a length of each of the top member 30 and the bottom member 32 such that the plurality of intersecting members 14 defines a rectangle. Additionally, each of the top member 30, the bottom member 32, the first lateral member 34 and the second lateral member 36 are comprised of a rigid material, including but not being limited to steel or aluminum. A screen 38 is attached to the frame 12 such that the screen 38 completely covers the opening 28 defined by the frame 12. Additionally, the screen 38 is comprised of a mesh material to pass air through the mesh screen 38 while inhibiting insects from passing through the screen 38. The mesh screen 38 has a perimeter edge 40 that is attached to a distal edge 42 of an outermost one of the pair of outward panels 44 associated with each of the plurality of intersecting members 14.

A curtain 46 is movably disposed in the frame 12 and the curtain 46 is pleated thereby facilitating the curtain 46 to be urged between a collapsed position and an expanded position. The curtain 46 extends across a full width of the frame 12 when the curtain 46 is in the expanded position. The curtain 46 is comprised of a fluid impermeable material to inhibit air from flowing through the frame 12 when the curtain 46 is in the expanded position. The curtain 46 has a top edge 48 and a bottom edge 50 and the curtain 46 has a plurality of pleats 52 each extending between the top edge 48 and the bottom edge 50. The pleats 52 are evenly spaced apart from each other and are distributed between a first lateral edge 54 and a second lateral edge 56 of the curtain 46.

The curtain 46 extends between the top member 30 and the bottom member 32 of the frame 12 having the curtain 46 being positioned between each of the pair of outward panels 26 associated with each of the top member 30 and the bottom member 32. Additionally, the first lateral edge 54 of the curtain 46 is attached to the central panel 24 associated with the first lateral member 34 of the frame 12.

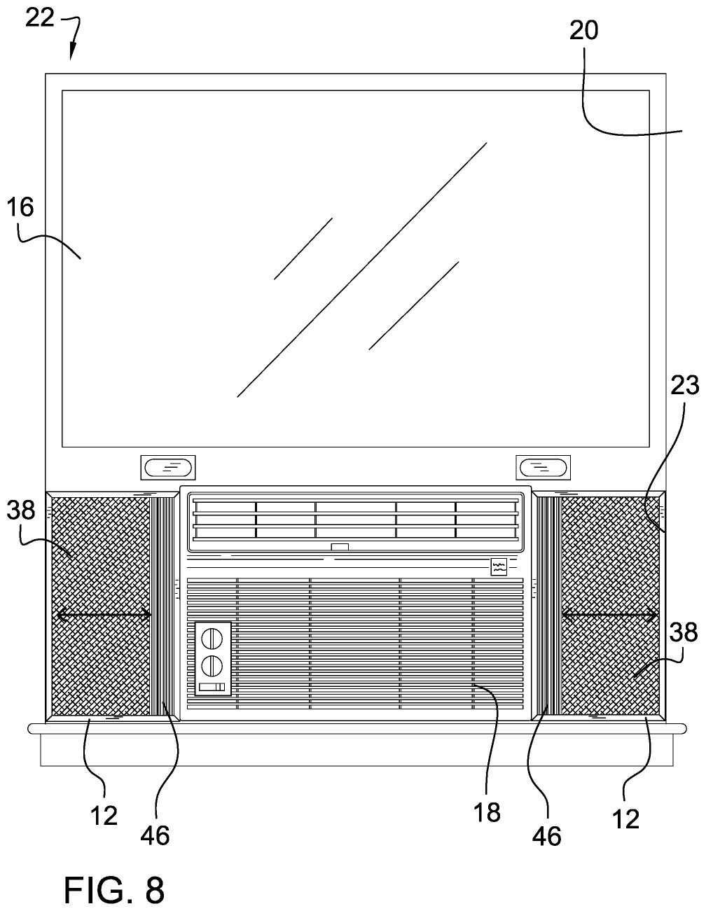

A slat 60 is included that has an upper end 62, a lower end 64 and a rear surface 66 extending between the upper end 62 and the lower end 64. The rear surface 66 is attached to the second lateral edge 56 of the curtain 46 such that the slat 60 is vertically oriented in the frame 12. The upper end 62 is positioned adjacent to the central panel 24 of the top member 30 and the lower end 64 is positioned adjacent to the central panel 24 of the bottom member 32. The slat 60 can be gripped for urging the curtain 46 between the expanded position and the collapsed position. The slat 60 rests against the central panel 24 of the second lateral member 36 having the pleats 52 being expanded when the curtain 46 is in the expanded position. The pleats 52 are folded when the curtain 46 is in the collapsed position having the slat 60 being spaced from the central panel 24 of the first lateral member 34. As is most clearly shown in FIG. 8, a pair of the frames 12, curtains 46 and screens 38 may be provided and each of the pair of frames 12, curtains 46 and screens 38 may be positioned on opposite sides of the window air conditioning unit 18.

In use, the curtain 46 is positioned in the expanded position to cover the screen 38 thereby inhibiting air to flow through the screen 38 when the window air conditioning unit 18 is being employed. In this way the window air conditioning unit 18 can cool the interior of the building 22 without losing cooled air through the screen 38. The curtain 46 can be positioned in the collapsed position to expose the screen 38 thereby facilitating air to flow through the screen 38 when the window air conditioning unit 18 is not being employed. In this way the room and be ventilated with cool during at night, for example, thereby reducing electricity consumption related to running the window air conditioning unit 18.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present. unless the context clearly requires that there be only one of the elements.

I claim:

1. A pleated window screen device that is positionable in a window located adjacent to a window air conditioning unit to facilitate ambient air to through window in lieu of running the window air conditioning unit, said device comprising:
a frame having a plurality of intersecting members being oriented at right angles with each other wherein said frame is configured to be positioned in a window next to a window air conditioning unit;
a screen being attached to said frame such that said screen completely covers an opening defined by said frame, said screen being comprised of a mesh material wherein said screen is configured to pass air through said mesh screen while inhibiting insects from passing through said screen; and
a curtain being movably disposed in said frame, said curtain being pleated thereby facilitating said curtain to be urged between a collapsed position and an expanded position, said curtain extending across a full width of said frame when said curtain is in said expanded position, said curtain being comprised of a fluid impermeable material wherein said curtain is configured to inhibit air from flowing through said frame when said curtain is in said expanded position.

2. The device according to claim 1, wherein each of said plurality of intersecting members comprises a central panel extending between a pair of outward panels, each of said outward panels associated with a respective one of said intersecting members being perpendicularly oriented with said central panel of said respective intersecting member such that each of said plurality of intersecting members has a U-shape, each of said outward panels associated with each of said intersecting members being coupled to a respective one of said outward panels associated with an adjacent one of said intersecting members such that each of said outward panels associated with each of said intersecting members is directed into an opening defined by said plurality of intersecting members, said central panel associated with each of said plurality of intersecting members is coupled to said central panel associated with a respective pair of said plurality of intersecting members.

3. The device according to claim 2, wherein said plurality of intersecting members includes a top member and a bottom member and a first lateral member and a second lateral member, each of said first lateral member and said second lateral member having a length being greater than a length of each of said top member and said bottom member such that said plurality of intersecting members defines a rectangle.

4. The device according to claim 2, wherein said mesh screen has a perimeter edge being attached to a distal edge of an outermost one of said pair of outward panels associated with each of said plurality of intersecting members.

5. The device according to claim 2, wherein said curtain has a top edge and a bottom edge, said curtain having a plurality of pleats each extending between said top edge and said bottom edge, said plurality of pleats being evenly spaced apart from each other and being distributed between a first lateral edge and a second lateral edge of said curtain, said curtain extending between said top member and said bottom member of said frame having said curtain being positioned between each of said pair of outward panels associated with each of said top member and said bottom member, a first lateral edge of said curtain being attached to said central panel associated with said first lateral member of said frame.

6. The device according to claim 5, further comprising a slat having an upper end, a lower end and a rear surface extending between said upper end and said lower end, said rear surface being attached to said second lateral edge of said curtain such that said slat is vertically oriented in said frame having said upper end being positioned adjacent to said central panel of said top member and having said lower end being positioned adjacent to said central panel of said bottom member thereby facilitating said slat to be gripped for urging said curtain between said expanded position and said collapsed position.

7. The device according to claim 6, wherein said slat rests against said central panel of said second lateral member having said pleats being expanded when said curtain is in said expanded position.

8. The device according to claim 6, wherein said pleats are folded when said curtain is in said collapsed position having said slat being spaced from said central panel of said first lateral member.

9. A pleated window screen device that is positionable in a window located adjacent to a window air conditioning unit to facilitate ambient air to through window in lieu of running the window air conditioning unit, said device comprising:
a frame having a plurality of intersecting members being oriented at right angles with each other wherein said frame is configured to be positioned in a window next to a window air conditioning unit, each of said plurality of intersecting members comprising a central panel extending between a pair of outward panels, each of said outward panels associated with a respective one of said intersecting members being perpendicularly oriented with said central panel of said respective intersecting member such that each of said plurality of intersecting members has a U-shape, each of said outward panels associated with each of said intersecting members being coupled to a respective one of said outward panels associated with an adjacent one of said intersecting members such that each of said outward panels associated with each of said intersecting members is directed into an opening defined by said plurality of intersecting members, said central panel associated with each of said plurality of intersecting members being coupled to said central panel associated with a respective pair of said plurality of intersecting members, said plurality of intersecting members including a top member and a bottom member and a first lateral member and a second lateral member, each of said first lateral member and said second lateral member having a length being greater than a length of each of said top member and said bottom member such that said plurality of intersecting members defines a rectangle;
a screen being attached to said frame such that said screen completely covers said opening defined by said frame, said screen being comprised of a mesh material wherein said screen is configured to pass air through said mesh screen while inhibiting insects from passing through said screen, said mesh screen having a perimeter edge being attached to a distal edge of an outermost one of said pair of outward panels associated with each of said plurality of intersecting members;
a curtain being movably disposed in said frame, said curtain being pleated thereby facilitating said curtain to be urged between a collapsed position and an expanded position, said curtain extending across a full width of said frame when said curtain is in said expanded position, said curtain being comprised of a fluid impermeable material wherein said curtain is configured to inhibit air from flowing through said frame when said curtain is in said expanded position, said curtain having a top edge and a bottom edge, said curtain having a plurality of pleats each extending between said top edge and said bottom edge, said plurality of pleats being evenly spaced apart from each other and being distributed between a first lateral edge and a second lateral edge of said curtain, said curtain extending between said top member and said bottom member of said frame having said curtain being positioned between each of said pair of outward panels associated with each of said top member and said bottom member, a first lateral edge of said curtain being attached to said central panel associated with said first lateral member of said frame; and
a slat having an upper end, a lower end and a rear surface extending between said upper end and said lower end, said rear surface being attached to said second lateral edge of said curtain such that said slat is vertically oriented in said frame having said upper end being positioned adjacent to said central panel of said top member and having said lower end being positioned adjacent to said central panel of said bottom member thereby facilitating said slat to be gripped for urging said curtain between said expanded position and said collapsed position, said slat resting against said central panel of said second lateral member having said pleats being expanded when said curtain is in said expanded position, said pleats being folded when said curtain is in said collapsed position having said slat being spaced from said central panel of said first lateral member.
